(19) United States
(12) Patent Application Publication
(10) Pub. No.: US 2022/0297607 A1
(43) Pub. Date: Sep. 22, 2022

(54) Vehicle Mounted Step Assist System

(71) Applicant: Lee Bornschlegel, Prescott, AZ (US)

(72) Inventor: Lee Bornschlegel, Prescott, AZ (US)

(21) Appl. No.: 17/514,014

(22) Filed: Oct. 29, 2021

Related U.S. Application Data
(60) Provisional application No. 63/161,665, filed on Mar. 16, 2021.

(51) Int. Cl. B60R 3/00; B60N 3/02

(52) U.S. Cl. CPC B60R 3/007; B60N 3/026

(57) ABSTRACT

The present invention relates generally to the field of vehicle accessories and more specifically, to a vehicle-mounted step and handle assist system for climbing into a pickup truck or gaining entry into a vehicle interior. The system includes a portable step and a hand grip unit. The step is uses a hinged foot plate and a perpendicular bolt assembly to secure the device to a vehicle by a D-ring configuration. The hand grip unit uses the conventional striker bolts installed on a truck or other vehicle to attach a grip unit having pull handle that can aid a user by providing additional support while using the step and entering into the vehicle.

### CROSS-REFERENCE TO RELATED APPLICATION

The present application claims priority to, and the benefit of U.S. Provisional Application No. 63/161,665, which was filed on Mar. 16, 2021, and is incorporated herein by reference in its entirety.

### FIELD OF THE INVENTION

The present invention relates generally to the field of vehicle accessories. More specifically, the present invention relates to a vehicle-mounted tailgate step assist system for climbing into a pickup truck bed or other vehicle having a raised area. The system is comprised of a portable step and a hand grip unit. The step has a tubular steel body featuring a hinged foot plate and a perpendicular bolt assembly to secure the invention within the tailgate lock. A D-ring is incorporated to provide initial stability to the unit. There is a rubber or gripping layer that rests against the outer ridge to provide additional stability to the step when activated, while also preventing damage to the vehicle exterior when the step is expanded. The hand grip unit uses the conventional striker bolts installed on a truck or vehicle to attach a grip unit. Accordingly, this disclosure makes specific reference thereto the present invention. Nonetheless, it is to be appreciated that aspects of the present invention are also equally applicable to other like applications, devices and methods of manufacture.

### BACKGROUND OF THE INVENTION

By way of background, vehicles such as pickup trucks have a tailgate that swings down to create a flat surface that is even with the truck bed. These types of tailgates, in combination with a flat surface area such as a truck bed, are very helpful for hauling objects. From time to time it is necessary for an individual to climb in and out of the tailgate to place or remove an object from the truck bed. The height of most full-size truck beds can present difficulty for many to gain full access without some form of step assistance.

In addition, an individual moving cargo in or out of a pickup bed or vehicle bed is often forced to crawl or slide over the tailgate in an unnatural position while carrying a significant amount of weight. This action can lead to discomfort, intensify existing body and joint pans and even cause injury in the process to an individual, but especially an older person or a person with existing physical impairments. Further, even repeatedly entering and exiting a pickup bed can be exhausting and time-consuming for a completely healthy individual.

To overcome these problems, an individual may travel with a step stool, step ladder or other device to aid the individual in climbing into or out of the bed of a pickup truck or other vehicle body. However, such devices may be of insufficient height or strength, difficult to position securely on uneven ground and can be inadvertently kicked out of position, all of which can cause serious injury to the individual. Further, constantly carrying such a device in the bed of a pickup or vehicle may become extremely annoying to an individual, as the device may shift in position and rattle around in the back of the vehicle every time the vehicle moves.

In order to overcome these issues and to allow an individual to easily climb into the bed of a pickup or other vehicle, fold out step devices have been created. Such steps are typically located underneath the bumper of a pickup or vehicle and extend outwards towards the sides of the vehicle. The fold out step can be used when the tailgate is in the down position, such that the device covers a portion of the bumper. However, existing fold out step devices known in the art usually have a small surface area to place an individual's foot. This small surface area can make it extremely difficult to use the device when attempting to get a large object into the vehicle bed and when using the device to step into the vehicle. As a result, an individual can slip on the surface of the step while holding a large object, which may cause serious injury. Further, the tailgate steps of such devices are often located at the trailing edge of the tailgate, which can lead to difficulties in loading material into the bed, as the device obstructs the area behind the bed. In addition, existing devices lack a means to provide additional support to individuals in the form of hand support for increased stability. Further, the cross-section and shape of a tailgate often places restrictions on the size and strength of a step mechanism that can be installed within the tailgate.

Therefore, there exists a long-felt need in the art for an auxiliary vehicle step device that allows people to gain access to the truck bed or vehicle with ease when a tailgate or door is in a down or open position. There is also a long-felt need in the art for a vehicle-mounted step assist system that provides a structural solid surface for stepping, in addition to a handle support for increased stability. Moreover, there is a long-felt need in the art for a vehicle-mounted step assist system that provides a non-slip surface, which enables an individual to safely step onto and then step into the bed of a truck profile vehicle. Additionally, there is a long-felt need in the art for a vehicle-mounted step assist system that is detachable and allows individuals to release the device from a pickup truck or other vehicle. Further, there is a long-felt need in the art for a vehicle mounted step assist system that can be used with pickup trucks or other vehicles having a high profile. Finally, there is a long-felt need for a vehicle mounted step assist system that allows an individual to step into a truck or vehicle bed without applying significant pressure to their knees, and while providing additional support by utilizing the help of the upper body and hands.

The subject matter disclosed and claimed herein, in one embodiment thereof, comprises a vehicle-mounted step assist system. The system is designed to be retrofitted or integrated on to a vehicle such as a pickup truck or other vehicle having a high-profile, and is used to gain ingress and provide egress from the vehicle bed or vehicle interior while providing increased stability and support. The system has a portable step and a hand grip unit. The portable step includes a tubular shaft, a hinged foot plate attached to bottom of the shaft, a perpendicular bolt assembly to secure within a cavity positioned at a side edge of the tailgate of the vehicle, a D-ring configuration providing additional stability by attaching to a heavy duty anchor clip installed on the tailgate or vehicle body and a rubber layer that rests against the outer ridge for providing additional stability. The bolt assembly, D-ring configuration and rubber layer are further positioned near the top of the tubular shaft. The hand grip unit is configured to attach to a striker bolt and has a hollow tumbler tube including a cam assembly, such that the hollow tumbler tube secures onto the striker bolt and a pull handle is used for rotating the cam. The hand grip located at the top of the unit also designed to be held by a user when the user steps onto the hinged foot plate of the tailgate step or vehicle body for additional security and stability.

In this manner, the vehicle-mounted step assist system of the present invention accomplishes all of the forgoing objectives and provides a relatively easy, cost-effective, and convenient system to step into a truck bed or vehicle body with ease and without applying significant pressure to the knees of the user. Using the vehicle-mounted step assist system, a user can also gain access to a truck bed or vehicle interior when the tailgate is in the down position or the door or entry point is open, and the system does not block the area behind the truck bed or vehicle entry point. Further, a user is provided with additional support for ingress and egress in the form of the hand grip unit which can be grabbed.

### SUMMARY OF THE INVENTION

The following presents a simplified summary in order to provide a basic understanding of some aspects of the disclosed innovation. This summary is not an extensive overview, and it is not intended to identify key or critical elements or to delineate the scope thereof. Its sole purpose is to present some general concepts in a simplified form as a prelude to the more detailed description that is presented later.

The subject matter disclosed and claimed herein, in one embodiment thereof, comprises a vehicle-mounted step assist system. The system is configured to allow a user to ingress and egress a tailgate of a vehicle such as a pickup truck, or the interior area of a high profile vehicle, while providing increased stability and support. The system further includes a tailgate step to work in conjunction with a hand grip unit. The tailgate step has a tubular shaft, a hinged foot plate attached to the bottom of the shaft, a perpendicular bolt assembly to secure the assembly within a cavity positioned at a side edge of the tailgate or body portion of the vehicle, a D-ring configuration providing additional stability by attaching to a anchor clip installed on the tailgate, and a rubber layer that rests against the outer tailgate ridge for providing additional stability. The bolt assembly, D-ring configuration, and the rubber layer are further positioned near the top of the tubular shaft. The hand grip unit is configured to attach to a striker bolt and has a hollow tumbler tube including a cam. The hollow tumbler tube secures onto a striker bolt and the pull handle is used for rotating a cam, and a hand grip that is designed to be held by a user when the user steps onto the hinged foot plate of the step for additional security and stability.

In a further embodiment of the present invention, a vehicle-mounted step assist system is disclosed. The system has a plurality of components including a perpendicular bolt for securing a step to a vehicle lock cavity, a D-ring anchor system positioned above the bolt and designed to be fastened to a anchor clip, a horizontal rubber layer positioned below the bolt for providing additional support with a ridge on a portion of the body, a non-slip surface or step for a person to safely step on to and then step into the truck or other vehicle. The components are attached to a longitudinal and if need be telescopic shaft that can be installed at any side of the tailgate or vehicle body.

A further embodiment of the present invention may also include a hand grip unit. The hand grip unit is designed to be used by an individual for additional support when stepping on the step of the system. The hand grip unit includes a pull handle and a cam assembly that engulfs a striker bolt typically found on a mounting surface of a truck, vehicle or trailer. The pull handle is used for rotating the cam assembly, while eliminating any lateral movement being secured to the striker bolt engulfed within the assembly.

In differing embodiments, the step of the system can be attached to the vehicle lock cavity and used when the tailgate is in the down position or an entry point to the vehicle is open and accessible. The step has a tubular steel body featuring a hinged foot plate and a perpendicular bolt assembly to secure the invention within the cavity. A D-ring is incorporated to provide initial stability to the unit. There is a rubber or gripping layer that rests against the outer ridge to provide additional stability to the step when activated, while also preventing damage to the vehicle exterior when the step is expanded. Once installed on the shaft, the step creates a fulcrum and several anchor points to maintain stability in the expanded position. The step also has a non-slip surface and allows a user to take just two steps upward to enter the truck bed or vehicle body.

In various other embodiments, the vehicle-mounted step assist system may have a plurality of modified features. For example, in one embodiment the striker bolt has a flanged head and the bolt is mounted to the vehicle using a rigid mounting plate and a backer plate that also comprises the present invention. Both plates can be mounted by a user to an existing vehicle in order to provide additional structurally stability and rigidity to the device. In another embodiment of the present invention, the hollow tumbler has a predefined slot or slots to receive and accommodate the flanged head of the striker bolt to form a secure connection and rotation while eliminating lateral movement being secured to the striker bolt within the tumbler. The hollow tumbler can also have one and at most two slots. In a further embodiment, the cam system supported by the tumbler is activated when the pull handle is pulled down.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1A illustrates a perspective view of one potential embodiment of a vehicle-mounted step assist system of the present invention in accordance with the disclosed architecture;

FIG. 1B illustrates a perspective view of another potential embodiment of a vehicle-mounted step assist system of the present invention in accordance with the disclosed architecture;

FIG. 2 illustrates a perspective view of one potential embodiment of a vehicle-mounted step assist system of the present invention when attached to a vehicle in accordance with the disclosed architecture;

FIG. 3 illustrates a perspective view of one potential embodiment of a vehicle-mounted step assist system of the present invention attached to a vehicle in accordance with the disclosed architecture;

FIG. 4A illustrates a perspective view of one potential embodiment of a hand grip unit of the vehicle-mounted step assist system of the present invention in accordance with the disclosed architecture;

FIG. 4B illustrates a side perspective view of one potential embodiment of a hand grip unit of the vehicle-mounted step assist system of the present invention with the cam in an unwedged position in accordance with the disclosed architecture;

FIG. 4C illustrates a side perspective view of one potential embodiment of a hand grip unit of the vehicle-mounted step assist system of the present invention with the cam in a wedged position in accordance with the disclosed architecture;

FIG. 5 illustrates a side perspective view of one potential embodiment of a hand grip unit of the vehicle-mounted step assist system of the present invention in accordance with the disclosed architecture;

FIG. 6 illustrates a top perspective view of one potential embodiment of a hand grip unit of the vehicle-mounted step assist system of the present invention in accordance with the disclosed architecture;

FIG. 7A illustrates a perspective view of one potential embodiment of a tumbler of the vehicle-mounted step assist system of the present invention in accordance with the disclosed architecture;

FIG. 7B illustrates a perspective view of one potential embodiment of a tumbler of the vehicle-mounted step assist system of the present invention in accordance with the disclosed architecture;

FIG. 7C illustrates a perspective view of one potential embodiment of a tumbler of the vehicle-mounted step assist system of the present invention in accordance with the disclosed architecture;

FIG. 8 illustrates a front perspective view of one potential embodiment of a tumbler of the vehicle-mounted step assist system of the present invention in accordance with the disclosed architecture; and

FIG. 9 illustrates a block diagram of one potential embodiment of a commercially available kit of the vehicle-mounted step assist system of the present invention in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a vehicle accessory that allows people to gain access to a truck bed or high-profile vehicle with ease when a tailgate is in a down position, or an entry point is in an open position. There is also a long-felt need in the art for a vehicle-mounted step assist system that provides a structurally solid surface for stepping, a handle support, and a non-slip surface which enables an individual to safely step onto and then step into the bed of a truck or interior of a vehicle using the system. Additionally, there is a long-felt need in the art for a vehicle-mounted step assist system that is detachable and allows an individual to release the device from a pickup truck or other vehicle having a high profile. Further, there is a long-felt need in the art for a vehicle-mounted step assist system that can be used with pickup trucks or other vehicles that allow an individual to step into truck bed or enter into a vehicle interior without applying significant pressure to the knees, and while providing additional support by utilizing the hand and upper body as well in the process.

The present invention, in one exemplary embodiment, is a novel vehicle-mounted step assist system that allows a user to gain access to a truck bed or interior of a vehicle or trailer. The step assist system has a plurality of components including a perpendicular bolt for securing the step to a vehicle body lock cavity, a D-ring anchor system positioned above the bolt and designed to be fastened to a anchor clip, a horizontal rubber layer positioned below the bolt for providing additional support with a body ridge and a non-slip surface or step for a person to safely step on to and then step into the truck bed or vehicle interior. The components are attached to a longitudinal and telescoping shaft (where needed) that can be installed on any side of the vehicle body, such as the tailgate or entry point into the vehicle or trailer.

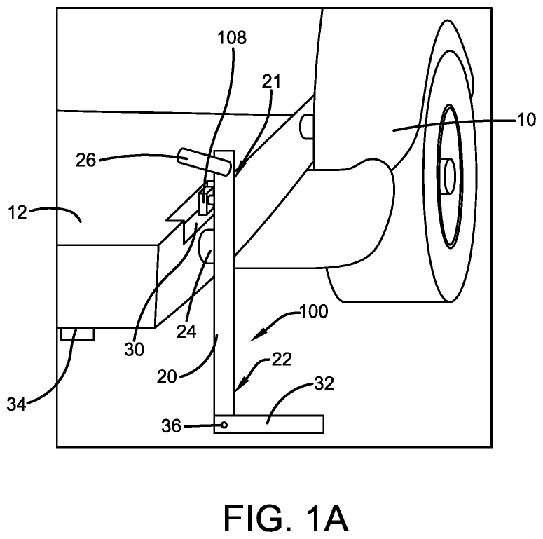

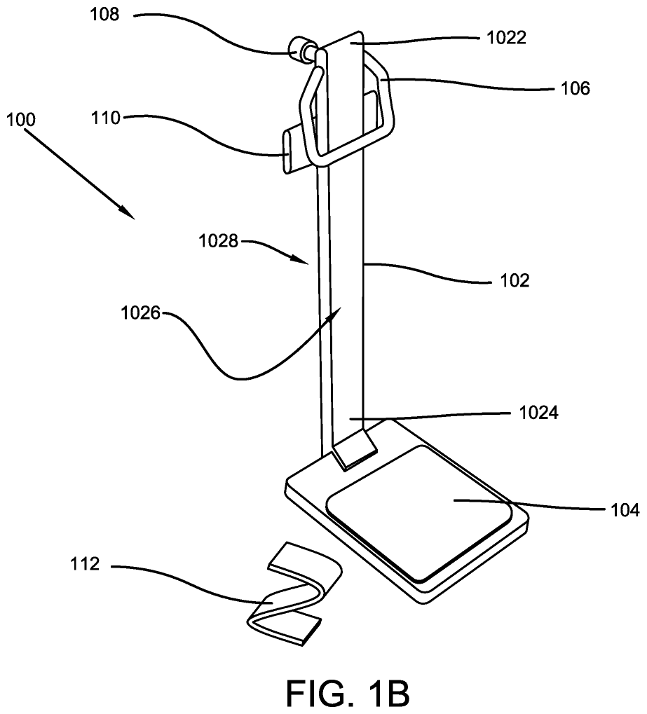

Referring initially to the drawings, FIG. 1A illustrates a perspective view of one potential embodiment of a vehicle-mounted step assist system 100 of the present invention in accordance with the disclosed architecture. The system 100 allows a user to easily climb into or out of a pickup truck 10 bed or enter into the interior of a vehicle body of high suspension using a step 32. More specifically, the system 100 has a vertical shaft 102 having a top end 21 and a bottom end 22. A non-slip step 32 is detachably-attached to the shaft 102 at the bottom end 22 of the shaft 20 via a hinge 36 (or fixedly attached to the shaft 102) and enables a user to safely step onto the step 32 and then into the bed or interior of a vehicle. Once installed on the shaft 102, the step 32 when in use creates a fulcrum and several anchor points on the shaft 20 that allows the step 32 to remain in a stable position. At the top end 21 of the shaft 102, is a mounting assembly that includes a steel D-ring 26 anchor system that is permanently attached and is positioned to securely receive a generally S-shaped strap/anchor clip 112. The strap/clip 112 is designed to be detachably-installed on the inner framework of a tailgate of a pickup truck 10 to provide additional support to the shaft 102. A perpendicular bolt 23 extends laterally from the shaft 20 and is attached to near the top end 21 of the shaft 20. The bolt 23 secures the system 100 within the tailgate latch 30 with an audible clicking sound to communicate to a user that the system 100 has been safely and securely installed. The system 100 can further be removed from a tailgate latch 30 via pulling a release handle 34 located on some portion of the pickup 10, but preferably on the tailgate 12. In order to protect the exterior finish of the pickup 10 or vehicle, the shaft 20 may also have a removably or fixedly attached rubber pad 24.

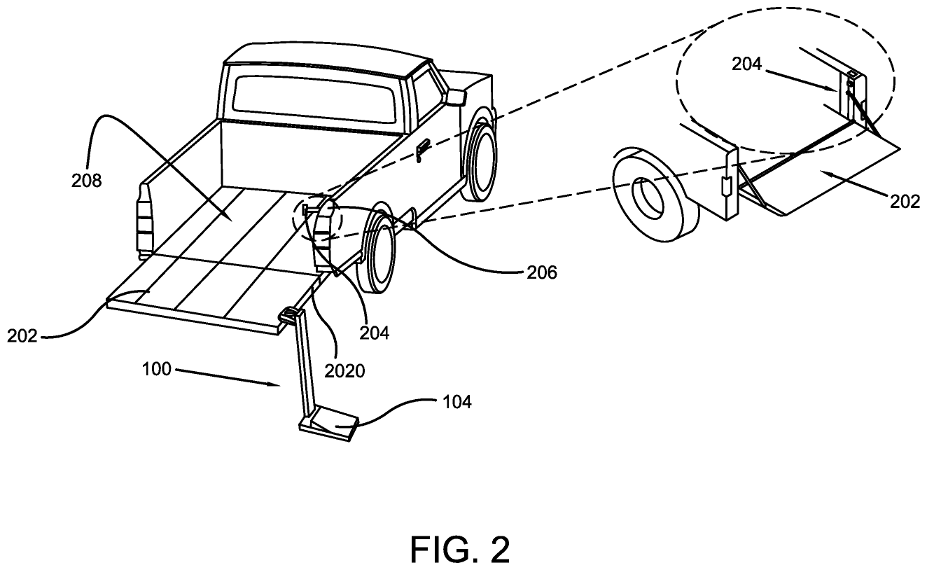

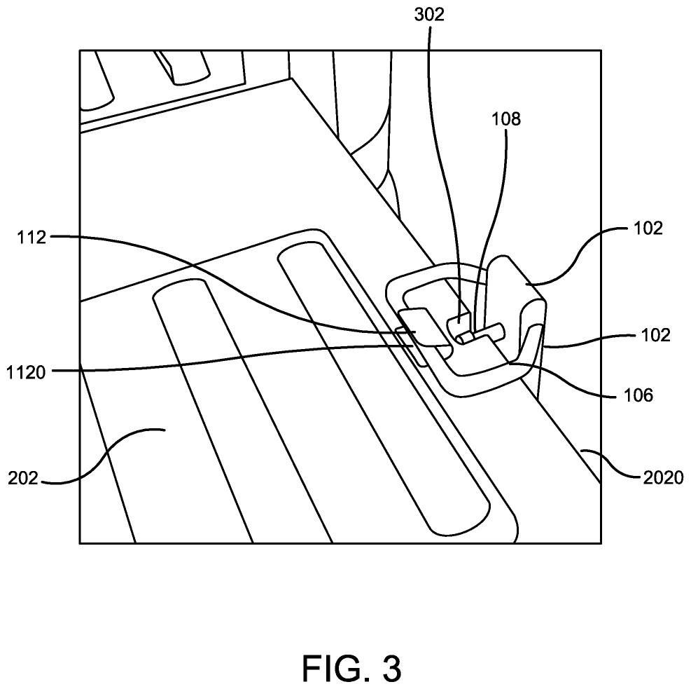

FIG. 1B illustrates a perspective view of one potential embodiment of a vehicle-mounted step assist system 100 of the present invention in accordance with the disclosed description. The system 100 allows a user to easily climb into or out of a pickup truck bed 208 or enter into the interior of a vehicle body using a step 104. More specifically, the system 100 can be designed with a height-adjustable, tubular shaft 102 having a top end 1022 and a bottom end 1024. By providing a height adjustable shaft, the step assist system can be attached to different sizes and types of vehicles. A non-slip step 104 is detachably-attached to the shaft 102 at the bottom end 1024 on the front surface 1026 of the shaft 102 and enables a user to safely step onto the step 104 and then into the bed or interior of a vehicle 208. Once installed on the shaft 102, the step 104 creates a fulcrum and several anchor points on the shaft 102 that allows the step 104 to remain in a stable position when in use. At the top end 1022 of the shaft 102, is a mounting assembly that includes a steel D-ring 106 anchor system which is permanently attached and is positioned to securely receive an anchor anchor clip 112. The anchor clip 112 is designed to be detachably-installed on to a body portion of a vehicle such as a tailgate 202 to provide additional support to the shaft 102. A perpendicular bolt 108 extends laterally from the rear surface 1028 of the shaft 102 and is attached to near the top end 1022 of the shaft 102. As seen in FIG. 2 and FIG. 3, the bolt 108 secures the system 100 to a portion of the body lock cavity 302 located near the edge of a truck bed or other vehicle body element 208. For providing additional support to the system 100, a horizontal rubber layer 110 is disposed below the bolt 108 on the rear surface 1028 of the shaft 102. The rubber layer 110 rests against the side edge of the 2020 to provide additional stability when deployed. The system 100 is extendable to a deployed configuration for facilitating ingress and egress into and from a vehicle interior such as a truck bed, cargo area 208, and can be easily detached for permitting the closing of the body frame element 202 as desired.

FIG. 3 illustrates a perspective view of one potential embodiment of a vehicle mounted step assist system 100 of the present invention attached to a vehicle body element such as a tailgate 202 in accordance with the disclosed structure. As shown, a cavity 302 is commonly found at the side edge 2020 of the body, such as at the tailgate or vehicle entry point 202 of commercially available full-size trucks. The cavity 302 receives the perpendicular bolt 108 and a anchor clip 112 is installed near the cavity 302 on the body element 202. The perpendicular bolt 108 is fastened into the cavity 302 in the body of the vehicle and a D-ring 106 further secures the step assist system 100 by fastening or engaging with the anchor clip 112. The anchor clip 112 has a continuous opening 1120 through which the D-ring 106 is inserted into the anchor clip 112 to eliminate lateral movement of the shaft 102. To remove the system 100, the bolt 108 is removed from the cavity 302 and the D-ring 106 is removed and detached from the anchor clip 112 via the opening 1120. The detachable hand grip 500 (as will be discussed more fully below) uses a striker bolt 204 that mounts to a mounting surface of the truck bed or vehicle body 208 where the tailgate or door “strikes” the bolt for closing of the opening.

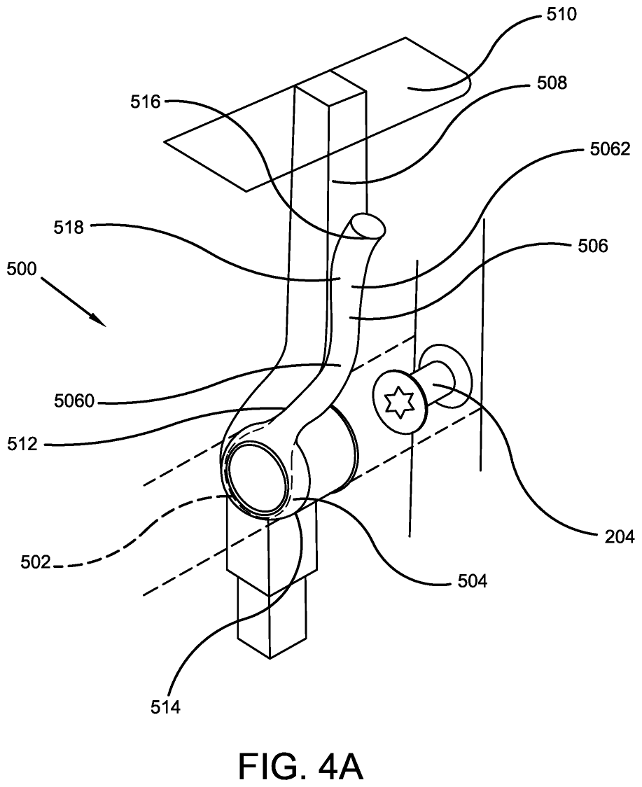

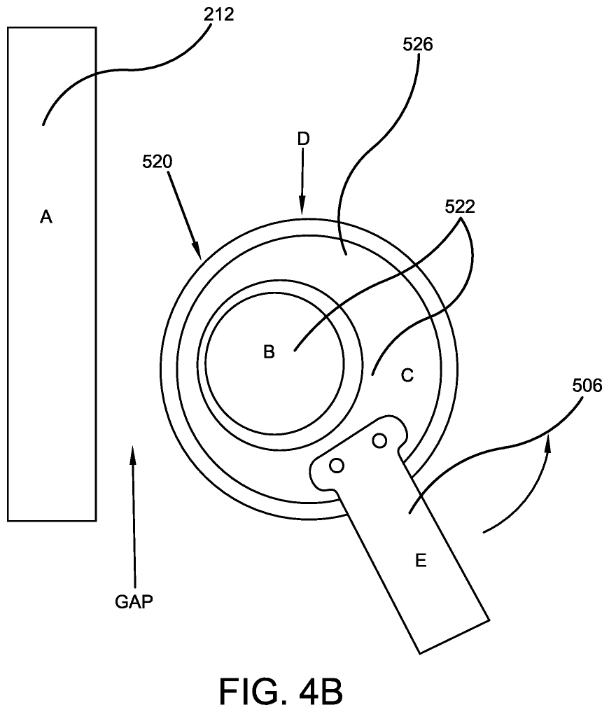

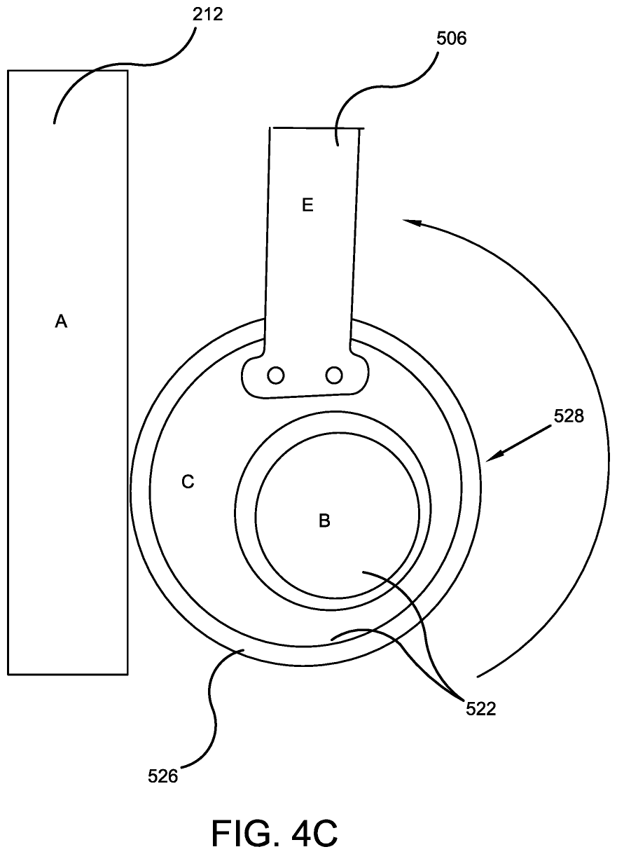

FIG. 4A illustrates a perspective view of one potential embodiment of a hand grip unit 500 of the vehicle mounted step assist system 100 of the present invention. The detachable hand grip unit 500 is specifically used for providing hand support to a user and is configured to lock in different positions and allowing the system 100 to be transferred to the opposite side of a truck 10 using the same procedure for locking. The detachable hand grip 500 is configured to lock onto the striker bolt 204 (original factory equipment). The detachable hand grip unit 500 has a hollow tumbler tube 502 that receives the striker bolt 204 to create a secure connection. The hollow tumbler tube 502 is dimensioned as per the standard sizes of the striker bolts 204 available in commercial trucks, vehicles and trailers, and also has inner cam assembly 520 that allows for easy rotation of a pull down handle 506. A fork 504 connects to the hollow tumbler 502 and is integrally connected to the handle 506. The handle 506 can pivot along the tumbler 502 that engulfs the striker bolt 204. The tumbler 502 has an integrated central cam assembly 520 that allows for smooth rotation of the pull handle 506 and attaching and detaching the grip unit 500.

The detachable hand grip 510 has a main shaft 508 that can be made from 1″ sq. tube in this example, or aluminum alloy of suitable strength and is approximately 13″ in length. The handle 506 has a plurality of bends 5060, 5062 built-in, to allow the handle 506 to avoid the truck bed or vehicle interior hardware (not shown) and locates the hand grip in closer proximity to the user. The handle 506 is mounted to a sleeve 516 within a sleeve jacket 518 that functions as an outer cover, and the outer sleeve jacket 518 is welded to the vertical main 1″ sq. shaft 508 at a plurality of welding points 512, 514. It should be appreciated that an inner sleeve 516 of the handle 506 and cam tumbler 502 are allowed to rotate inside the outer sleeve jacket 518, and are activated by the pull handle fork 504. The sleeve jacket 518 may include any type of deformable or compressible material such as a polyurethane foam or a rubber sleeve to facilitate gripping of the handle. While the handle 506 is moved and the tumbler 502 is rotated, the hand grip 510 remains stationary and stable, especially when the handle 506 is pressed down. The hand grip unit 500 works in combination with the step 104 to provide easier and safer truck bed or vehicle interior entry by giving additional hand support in addition to the step 104. The hand grip unit 500 provides additional points of contact for a user, improving the user's balance and making the process of getting into the truck bed or vehicle interior 208 easy and safe, and substantially reducing the possibility of injury.

FIGS. 4B and 4C illustrates a side perspective view of one potential embodiment of a hand grip unit of the vehicle mounted step assist system of the present invention with the cam in an unwedged and wedged position in accordance with the disclosed structure. As noted above, the integrated central cam assembly 520 allows for smooth rotation of the pull handle 506 and attaching and detaching the grip or handle unit 500. The cam assembly 520 may be concealed within the tumbler 502 (or the tumbler 502 may be concealed within the cam assembly 520) and has a pivot point 522, a cam 524, a cam housing 526, and the handle 506. The pivot point 522 may be in the form of a cam pin in one embodiment, where the pin has no head but is still retained within the housing 526. When the handle 506 is rotated upwards, the assembly 520 is pushed against the sidewall 212 of the tailgate or vehicle body 212 and/or truck bed 208, as shown in FIG. 4C. The pushing of the assembly 520 is accomplished by a horizontal thrust force created by the interaction of the slots 804, 8080, 8082 of a tumbler 802 and the bolt head 8060, 8100, 8180. Further, the thrust force eliminates side sway of the unit 500 when in use.

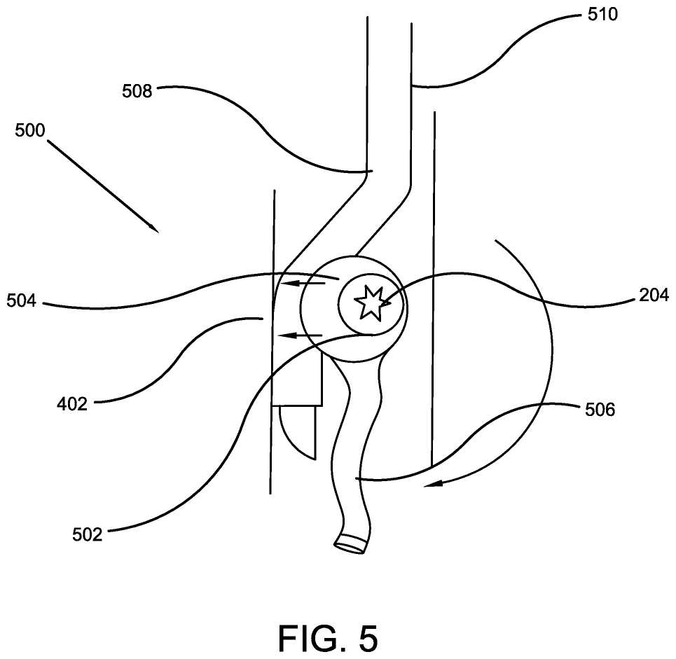

FIG. 5 illustrates a perspective side view of one potential embodiment of a hand grip unit 500 of the vehicle-mounted step assist system 100 of the present invention in accordance with the disclosed structure. As stated earlier, the handle 506 is configured to be pulled down by a user when the grip unit 500 is fitted over the striker bolt 204. As also shown in FIG. 4A, the hollow tumbler 502 is fitted over the striker bolt 204 and the handle 506 is configured to rotate using the fork 504. During the movement of the handle 506, the grip 510 becomes rigid and is designed to be held by a user during ingress and egress movement from the truck bed, trailer or vehicle body 208, wherein the grip 510, handle 506 and unit 500 remains stable and secure and does not move laterally.

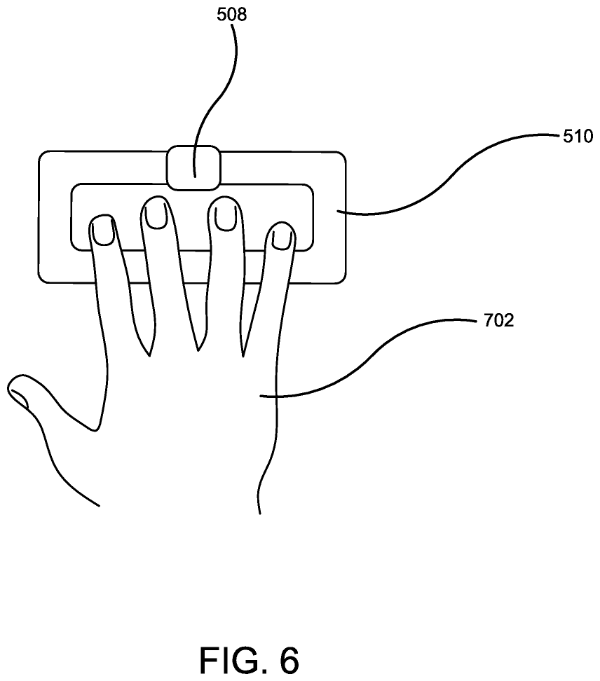

FIG. 6 illustrates a perspective top view of one potential embodiment of a hand grip unit 500 of the vehicle-mounted step assist system 100 of the present invention in accordance with the disclosed specification. At the top of the unit 500, an ergonomic and comfortable grip 510 is positioned. The grip 510 is positioned at an optimal height for a user to eliminate any bending or imbalance of the user while entering or leaving the truck bed or vehicle body 208. A user can easily hold the grip 510 in their hand 702, and in a differing embodiment the grip 510 may be padded for additional comfort.

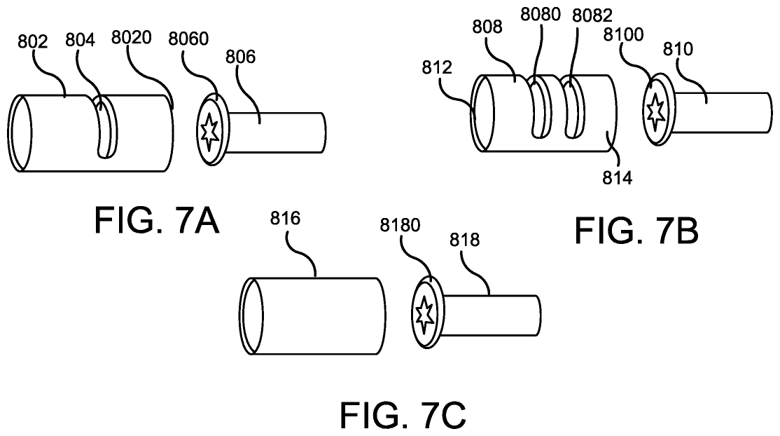

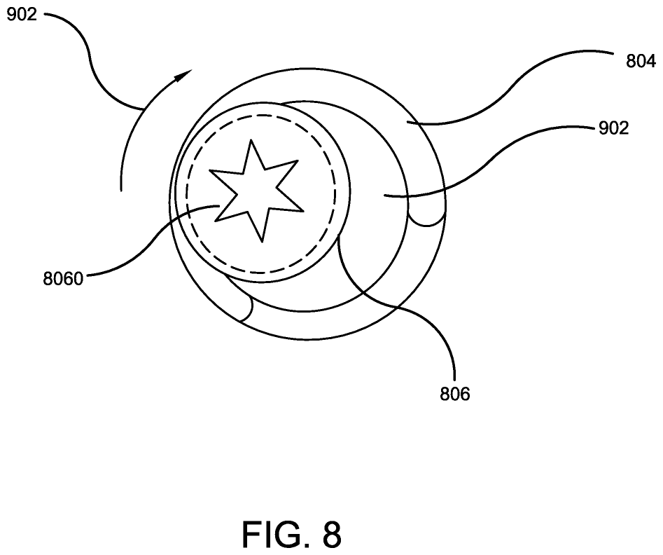

FIGS. 8A, 8B and 8C illustrate differing embodiments of tumblers 502 that fit onto exemplary striker bolts 204 available in standard full-size trucks and vehicles for various domestic and foreign models in accordance with the disclosed structure. As shown in FIG. 7A, one embodiment of a tumbler 802 has a slot 804 which receives the head 8060 of the striker bolt 806, where the striker bolt 806 is generally available in commercial domestic and foreign trucks and vehicle makes and models and is of ¾″ in size and its metric equivalent. The slot 804 is also positioned at ¾″ from the end 8020, such that the flange head 8060 is fit into the slot 804. The diameter of the tumbler 802 is also designed to accommodate the head 8060 of the bolt 806. It should be appreciated that any embodiment of the tumbler 502 made for any specific vehicle brand, make, or model, can fit on the striker bolt 204 located on either side of said vehicle brand, make, or model (e.g. the tumbler 502 is ambidextrous).

FIG. 7B illustrates a striker bolt 810 available in different trucks and vehicles. The striker bolt 810 is 1″ in length and has a flange head 8100 that can fit into one of the two slots 8080, 8082 in the corresponding tumbler 808. Both the slots 8080, 8082 are designed to receive and accommodate the flange head 8100. To accommodate the 1″ striker bolt 810, the slot 8080 is positioned at a 1″ distance from first end 814 and the slot 8082 is positioned at a 1″ distance from the second end 812. FIG. 7C illustrates a striker bolt 810 available in additional truck models that has a flanged head 8180 as shown. The bolt 818 has a length of 1 7/16″ and a tumbler 816 without any slots and having the length 1 7/16″ is used for accommodating and locking in the bolt 818.

When the head of the striker bolt 806, 840, 818 is accommodated within a slot 804, 8080, 8082 of the tumblers 802, 808, 816, the tumbler 802, 808, 816 is able to rotate easily. Further, as the head 8060, 8100, 8180 is fixed in the slot 804, 8080, 8082 of the tumblers 802, 808, 816, the lateral movement of the bolt 806, 840, 818 within the tumbler is eliminated. When the cam 520 and the tumbler 802, 808, 816 are in activation, the chances of a bolt 806, 840, 818 coming out of the tumbler 802, 808, 816 are eliminated.

It should be appreciated that there are inner slots 804, 8080, 8082 along the length of the tumblers 802, 808, 816 that act as an inline circular path guiding the bolt head 8060, 8100, 8180 and ensure a solid fastening effect as the tumbler 802, 808, 816 proceeds and the pressure within the cam assembly 520 intensifies. It should also be appreciated that in any embodiment, the number of slots 804, 8080, 8082 in each tumbler 802, 808, 816 may be any number, depending on the particular striker bolt 806, 840, 818 being used in the vehicle.

FIG. 8 illustrates a front perspective view of one potential embodiment of a tumbler 802, 808, 816 of the vehicle-mounted step assist system 100 of the present invention in accordance with the disclosed specification. As stated earlier, the tumbler 802, 808, 816 is a hollow tube for receiving a striker bolt 806 and the cam assembly 520 allows rotation of the handle 506 as shown in FIGS. 4A-C and 6. As the rotation of the cam 520 within the tumbler 802 begins in the clockwise direction as shown through 902, the head 8060 of the striker bolt 806 drops into the slot 804 in the tumbler 802 and stays in the slot 804 until the rotation of the cam assembly 520 is reversed.

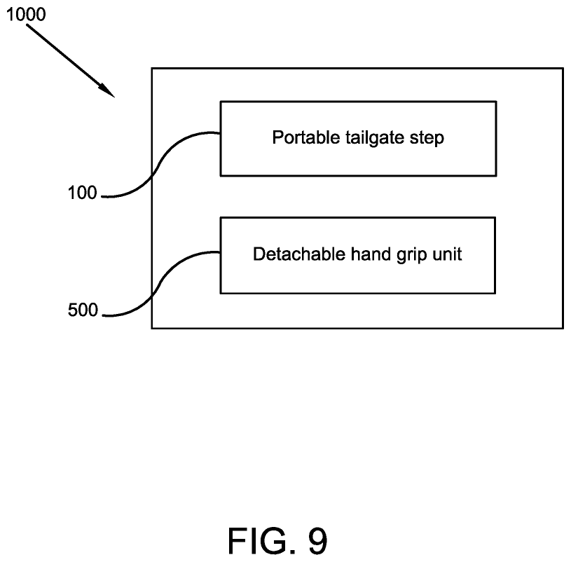

FIG. 9 illustrates a block diagram showing one potential embodiment of a commercially available kit of the vehicle-mounted step assist system 100 present invention in accordance with the disclosed specification. For consumers, the portable step 100 and the detachable hand grip unit 500 together can be a aftermarket kit 1000 and can be made for all commercial trucks that may also have an installed factory or after-market lift.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “vehicle mounted step assist system” and “system” are interchangeable and refer to the vehicle mounted step assist system 100 of the present invention. Similarly, as used herein “detachable hand grip unit”, “hand grip unit”, and “grip unit” are interchangeable and refer to the detachable hand grip unit 500 of the present invention.

Notwithstanding the forgoing, the vehicle mounted step assist system 100 and detachable hand grip unit 500 of the present invention can be of any suitable size and configuration as is known in the art without affecting the overall concept of the invention, provided that it accomplishes the above-stated objectives. One of ordinary skill in the art will appreciate that the size, configuration, and material of the vehicle mounted step assist system 100 and detachable hand grip unit 500 as shown in the FIGS. are for illustrative purposes only, and that many other sizes and shapes of the multipurpose plate with the vehicle mounted tailgate step assist system 100 and detachable hand grip unit 500 are well within the scope of the present disclosure. Although the dimensions of the with the vehicle mounted step assist system 100 and detachable hand grip unit 500 are important design parameters for user convenience, the vehicle-mounted step assist system 100 and detachable hand grip unit 500 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A vehicle mounted step assist system comprising:
a vertical shaft further comprised of a perpendicular bolt;
a step;
a D-ring;
an S-strap; and
a rubber pad.

2. The vehicle mounted step assist system of claim 1, wherein the vehicle mounted step assist system allows a user to easily climb into or out of a pickup truck bed or enter into an interior of a vehicle body of a high suspension.

3. The vehicle mounted step assist system of claim 1, wherein the rubber pad protects the exterior finish of a pickup or a vehicle that the vehicle mounted step assist system is attached to.

4. The vehicle mounted step assist system of claim 1, wherein the bolt can be secured within a tailgate latch of a vehicle and provides an audible clicking sound when in a locked position.

5. The vehicle mounted step assist system of claim 1, wherein the vehicle mounted step assist system can be released from the vehicle via pulling a release handle.

6. The vehicle mounted step assist system of claim 1, wherein the S-strap detachably installs to a inner framework a tailgate to provide additional support to the vertical shaft.

7. The vehicle mounted step assist system of claim 6, wherein the S-strap also attaches to the D-ring.

8. The vehicle mounted step assist system of claim 1, wherein the step enables a user to safely step onto the step and then into a bed or an interior of a vehicle.

9. The vehicle mounted step assist system of claim 8, wherein the step is a non-slip step.

10. The vehicle mounted step assist system of claim 8, wherein the step is fixedly or removably attached to the vertical shaft.

11. A vehicle mounted entry assist system comprising:
a vertical shaft having a top end and a bottom end;
a step secured to the bottom end;
a mounting assembly secured to the top end; and
a hand grip having a handle and a shaft, wherein the shaft is sized and configured to fit over a bar positioned at a vehicle entry point for securing the hand grip to the bar, and further wherein the hand grip and the vertical shaft are installed on the vehicle entry point separately from one another.

12. The vehicle mounted entry assist system of claim 11, wherein the mounting assembly comprises a D-shaped ring and an anchor clip for securing the vertical shaft adjacent the vehicle entry point.

13. The vehicle mounted entry assist system of claim 11, wherein the shaft comprises a cam having at least one slot, and further wherein the bar has a head for fitting within the at least one slot.

14. The vehicle mounted entry assist system of claim 11, wherein each of the hand grip and the step comprise a gripping surface.

15. The vehicle mounted entry assist system of claim 12, wherein the anchor clip is mounted to a body of a vehicle.

16. The vehicle mounted entry assist system of claim 13, wherein the cam comprises a pivot point and a cam housing.
